(19) United States
(12) Patent Application Publication
(10) Pub. No.: US 2005/0247915 A1
(43) Pub. Date: Nov. 10, 2005

(54) Compound for screen-printing, screen-printed layer and substrate provided with such layer

(75) Inventors: Gerard Cnossen, Opeinde (NL); Leo Hubert Maria Krings, Singapore (SG); Marcel Rene Boehmer, Eindhoven (NL); Gim Hong Tan, Singapore (SG)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/526,199

(22) PCT Filed: Jul. 31, 2003
(86) PCT No.: PCT/IB03/03713

§ 371 Date: Mar. 1, 2005

(30) Foreign Application Priority Data
Sep. 6, 2002 (SG) 02/00201

(51) Int. Cl. C09D 183/04

(52) U.S. Cl. 252/500; 427/282

(57) ABSTRACT

The invention relates to a compound for screen-printing. The invention also relates to a screen-printed layer, wherein the layer is formed by such a compound. The invention further relates to a substrate, preferably a utensil, wherein at least a part of a surface of the substrate is provided with such a layer.

The invention relates to a compound for screen-printing. The invention also relates to a screen-printed layer, wherein the layer is formed by such a compound. The invention further relates to a substrate, preferably a utensil, wherein at least a part of the surface of the substrate is provided with such a layer. High temperature resistant sol-gel coatings can, for example, be applied on lamps and iron soles. This is usually done by a spraying process. The sol-gel coatings generally have relatively good mechanical properties, such as scratch resistance, and are resistant to high temperatures. To obtain relatively thick layers, hybrid sol-gel precursors are used. To obtain a relatively good temperature and moisture resistance as well, mostly methyltrialkoxysilanes are used, often in combination with filler particles. Phenylalkoxysilanes also have a relatively good temperature stability.

The spraying process leads to homogeneous layers. However, for marking and decorating of objects a printing technique is required. An easy to use printing technique is screen-printing. However, the present screen-printing inks are not based on sol-gel materials. The generally used inks for screen-printing normally contain polyestersilicones or polyurethane which are not as scratch and temperature resistant as sol-gel materials.

Kalleder et al. J. Non. Cryst. Solids 218, 399 (1997) describes a non-hybrid sol-gel which does contain tetraethoxysilane (TEOS) and which is mixed with black pigments. This is also disclosed in EP0777633. To increase the viscosity of the mixture of sol-gel and pigments in order to adapt the mixture for screen-printing a hydroxypropylmethylcellulose (HPMC) is added. A drawback of said mixture is that the mixture must contain oxides of components as e.g. lead, boron and zinc for making low melting point glasses. Therefore the continuous phase of this mixture is not purely a sol-gel system.

Screen-printable sol-gel has also been used to make carbon ceramic electrodes to be used as sensors. In this application graphite powder is mixed with a small amount of a sol-gel material and a highly porous structure is printed. See Wang et al. Anal. Chem. 1998, 70, 1171 and U.S. Pat. No. 6,231,920, where also hybrid precursors are mentioned. As these printed layers are not dense, but substantially porous, these inks are not suitable for making scratch resistant markings and decorations on substrates e.g. on utensils.

It is an object of the invention to provide a sol-gel based improved compound for screen-printing, which leads to scratch resistant dense layers where the sol-gel materials make up the continuous phase.

This object of the invention is achieved by a compound as mentioned in the opening paragraph, which comprises at least one hybrid sol-gel precursor and a cellulose derivative. The advantage of the invention is, by choosing the correct filler particles or pigment particles to continuous phase ratio, dense layers can be printed in which the continuous phase is purely sol-gel. This avoids the use of low melting point frits and it still fulfils requirements on the mechanical properties of the layers.

In a preferred embodiment of the compound according to the invention hydroxypropylmethylcellulose (HPMC) is used as cellulose derivative in combination with the hybrid sol-gel precursor(s). Preferably, an organosilane compound containing three alkoxy groups is used as hybrid sol-gel. In this case, for example methyltri(m)ethoxysilane (NTMS or MTES), glycidoxypropyltri(m)ethoxysilane (GLYMO), or methacryloxypropyltri(m)ethoxysilane (MEMO) can be used as hybrid sol-gel. Small amounts of tetraethoxysilane can be used to improve adhesion.

In another preferred embodiment of the compound according to the invention, the compound comprises particles. Said particles can contribute to the desired properties of the compound or the screen-printed layer and may, for example, comprise pigment particles. The particles can be mixed into the hybrid sol-gel (ink). In case of pigments, preferably, pigments designed to optimize the scattering of light are used, such as titanium dioxide with a particle size around 200 nm to yield white decorations or markings. Organic or inorganic pigments with a small size, preferably smaller than 50 nm, can also be used to give transparent markings or decorations which are especially useful for substrates like glass and plastics. It may be obvious that the pigment particles are not restricted to scattering particles, but can also include e.g. transparent, coloured and scattering particles and or pigments, or combinations thereof. The dimensions of the particles are preferably chosen such that at least one dimension of substantially each particle does not exceed the thickness of a screen-printable layer which can be formed with the compound according to the invention.

To avoid drying of the ink on the screen, preferably alcohols are used which have a boiling point close to or higher than the boiling point of water. Butoxyethanol (boiling point 171° C.) and n-propanol (boiling point 97.4° C.) are preferred alcohols, but also other alcohols are suitable as they mix easily with the sol-gel-cellulose-particle mixture.

The invention also relates to a screen-printed layer, which layer comprises the above compound.

In a preferred embodiment of said layer, the thickness thereof is situated between 0.5 and 20 micrometer. Such thickness is very suitable for decorating and marking applications on utensils, such as domestic appliances like iron sole plates and hot plates for coffee makers and toasters. However, it is also imaginable to create layers with a thickness larger than 20 micrometer, for example 100 micrometer, or to create layers which consist in fact of a laminate of relatively thin layers.

In a preferred embodiment the formed layer is an at least substantially dense layer. The density of the screen-printed layer according to the present invention can commonly be compared with the density of the sprayed layers known in the art.

The printed layer is preferably cured by a thermal treatment, whereby the curing profile can be chosen such as to first evaporate the solvents at a relatively low temperature followed by a treatment at a higher temperature to densify the layer. At least a part of the cellulose derivative can be removed when curing is carried out above approximately 200° C.

The invention further relates to a substrate, wherein at least a part of the surface of the substrate is provided with said layer according to the invention. Advantageously, a surface of the substrate comprises glass, ceramic, plastic or metal. In particular, the substrate comprises a utensil. Preferably, the utensil comprises at least part of a domestic appliance, such as appliances used for garment care or appliances used in the preparation of food and/or beverages. Examples of the latter are coffee-makers, kettles, toasters, grills or ovens. The substrate may comprise the housing of such domestic appliances or the heating elements or hot plates therefor.

As domestic appliance, an iron sole plate can be decorated by the screen-printed layer according to the invention. Anodized aluminium iron sole plates can be spray-coated with a sol-gel coating. By printing a decorative pattern using sol-gel ink on the already deposited sol-gel coating, a material is locally deposited which has the same thermal properties, such as temperature resistance and coefficient of thermal expansion as the underlying sol-gel coating, which is very advantageous compared to non sol-gel based inks. It is even possible to apply a transparent or translucent coating on top of the printed substrate. For other heat producing utensils, such as toasters or coffee makers the same advantages can be achieved. On these utensils heat resistant hybrid sol-gel materials will be used, most often methyltrimethoxysilane and methyltriethoxysilane. The layers are thermally cured at a temperature well above the temperature in use.

On other substrates, like e.g. glass and plastics, sol-gel can also be screen-printed. Especially on plastic the curing temperature is limited and therefore different sol-gel precursors may be used which give sufficient cross-linking at low temperatures, such as glycidoxypropyltrimethoxysilane. For glass both glycidoxypropyltrimethoxysilane and methyltriethoxysilane are suitable. In a particular embodiment, the glass forms at least part of a domestic appliance, such as a toaster or a kettle. However, the screen-printed sol-gel layer can also be applied on, e.g., architectural glass or any other decorative glass part. The printed layers will have better thermal and scratch resistant properties than non sol-gel inks and are again especially useful in combination with other sol-gel layers, such as wear resistant sol-gel layers which can be applied on plastics.

The invention is further illustrated by the following non-restrictive examples.

### EXAMPLE 1

35 g of TiO₂ was dispersed on a roller bench with glass milling balls in 50 g of MTMS and 5 g of TEOS. After removal of the milling balls 15 g of H₂O and 0.35 g of acetic acid were added. In a different container 50 g of an aqueous silica (Ludox AS40) was acidified with 3.5 g of acetic acid. The two solutions were added together. The temperature increases due to the hydrolysis reaction and after cooling down 20 g of 10% HPMC in methoxypropanol (by weight) was added. The resulting paste showed shear thinning behaviour, but hardly any thixotropy and the viscosity at a shear rate of 100⁻¹ is between 2 and 3 Pa·s. The ink was screen-printed on an iron sole plate using a 325 mesh stainless steel screen. The aluminium sole plate had a sol-gel coating based on MTMS and was subjected to a corona treatment to make the surface hydrophilic. After printing the plates were dried at 80° C. and subsequently cured at 350° C. A white scratch resistant decoration with a thickness of 10 μm was formed.

### EXAMPLE 2

12.4 g of glycidoxypropyltrimethoxysilane was diluted with 23 grams of ethanol, after addition of 9 grams of water the pH was adjusted to 4.5 using acetic acid. After hydrolysing for one hour, 3 grams of Disperbyk 190 and 25 grams of TiO₂ were added. The TiO₂ pigment was dispersed using ball milling. After removal of the milling balls, 30 grams of a 6% hydroxypropylmethylcellulose solution in water were added followed by 30 grams of butoxyethanol. The resulting ink had a viscosity of 1.5 Pa·s at a shear rate of 100 s⁻¹ and was screen-printed using a 325 mesh stainless steel screen onto a glass substrate. After curing at 200° C. a white scratch resistant, well adhering pattern was obtained.

### EXAMPLE 3

12.4 g of glycidoxypropyltrimethoxysilane was diluted with 23 grams of ethanol, after addition of 9 grams of water the pH was adjusted to 4.5 using acetic acid. After hydrolyzing for one hour, 3 grams of Disperbyk 190 and 25 grams of TiO₂ were added. The TiO₂ pigment was dispersed using ball milling. After removal of the milling balls, 30 grams of a 6% hydroxypropylmethylcellulose solution in water were added followed by 30 grams of butoxyethanol. The resulting ink had a viscosity of 1.5 Pa·s at a shear rate of 100 s⁻¹ and was screen-printed using a 325 mesh stainless steel screen onto polycarbonate. After curing at 120° C. a white scratch resistant, well adhering pattern was obtained.

### EXAMPLE 4

15 g of water were added to 52 g of methyltriethoxysilane and 1 g of tetraethoxysilane. Hydrolysis took place for 6 hours, catalyzed by 0.15 g of acetic acid. 4 grams of disperbyk 190 and 35 grams of TiO₂ were added. After ball milling on a roller conveyor for 8 hours, 30 grams of a 6% hydroxypropylmethylcellulose solution in water were added followed by 30 grams of n-propanol. Screen-printing took place using a 400 mesh stainless steel screen on a corona pre-treated methyltrimethoxysilane based sol-gel coating on aluminium. After curing at 300° C. a white decorative, scratch resistance pattern was obtained.

### EXAMPLE 5

15 g of water were added to 52 g of methyltriethoxysilane and 1 g of tetraethoxysilane. Hydrolysis took place for 6 hours, catalyzed by 0.15 g of acetic acid. 4 grams of disperbyk 190 and 17 grams of TiO₂ and 17 grams of ZnFe₂O₄ were added. After ball milling on a roller conveyor for 8 hours, 30 grams of a 6% hydroxypropylmethylcellulose solution in water were added followed by 30 grams of butoxyethanol. Screen-printing took place using a 400 mesh stainless steel screen on a corona pre-treated methyltrimethoxysilane based sol-gel coating on aluminium. After curing at 300° C. a brown decorative, scratch resistance pattern was obtained.

### EXAMPLE 6

15 g of water were added to 52 g of methyltriethoxysilane and 1 g of tetraethoxysilane. Hydrolysis took place for 6 hours, catalyzed by 0.15 g of acetic acid. 5 g of a pigment dispersion of Cu-phtalocyanine (pigment blue 15:1) in a water/ethanol mixture was added followed by 30 grams of 6% hydroxypropylmethylcellulose solution in water were added, followed by 30 grams of butoxyethanol. Screen-printing took place using a 325 mesh stainless steel screen on glass substrates which were subsequently cured at 200° C. for 20 minutes. A transparent blue pattern with a thickness of 1.6 μm was obtained.

### EXAMPLE 7

13.7 g of methacryloxypropyltrimethoxysilane was mixed with 8.4 g of ethanol and stirred for a few minutes. 0.772 g of acetic acid was added to the above mixture and homogenized by magnetic stirring. 5 g of water (or alternatively 6.2 grams of Snowtex, a 20% silica sol in water) was subsequently added and the mixture is hydrolyzed for 1 hour with continuously stirring. Subsequently, 3.25 g of Disperbyk 190 and 26.3 g of TiO2 were added and the suspension was ball milled for 7 hours. After the milling balls were removed, 12.5 g of 6 wt % HPMC4 was added to 30 g of the suspension and hand shaken till a viscous paste was obtained. Finally 8.21 g of n-propanol was added as a drying control agent. Layers were printed through a 325 mesh screen on a glass substrate, dried at 80° C. for 45 minutes and cured at 150° C. for 30 minutes. Well adhering layers were obtained.

1. Compound suitable for screen-printing containing at least one hybrid sol-gel precursor and cellulose derivative.

2. Compound as claimed in claim 1, characterized in that hydroxypropylmethylcellulose (HPMC) is used as cellulose derivative.

3. Compound as claimed in claim 1, characterized in that an organosilane compound containing three alkoxy groups is used as hybrid sol-gel.

4. Compound as claimed in claim 1, characterized in that the compound comprises particles.

5. Screen-printed layer, wherein the layer comprises the compound of claim 1.

6. Screen-printed layer as claimed in claim 5, characterized in that the thickness of the layer is situated between 0.5 and 20 micrometer.

7. Screen-printed layer as claimed in claim 5, characterized in that the layer is a substantially dense layer.

8. Substrate, wherein at least a part of the surface of the substrate is provided with the layer as claimed in claim 5.

9. Substrate according to claim 8, characterized in that a surface thereof comprises glass, ceramic, plastic or metal.

10. Substrate according to claim 8, characterized in that it comprises at least part of a domestic appliance.

11. Substrate according to claim 10, characterized in that it comprises at least part of an iron.

12. Substrate according to claim 10, characterized in that it comprises at least part of an apparatus for preparing food and/or beverages.

13. Substrate according to claim 12, characterized in that it comprises a hot plate.

14. Substrate according to claim 8, characterized in that it comprises architectural glass.
